(19) United States
(12) Patent Application Publication
(10) Pub. No.: US 2018/0218052 A1
(43) Pub. Date: Aug. 2, 2018

(54) EXTENSIBLE DATA DRIVEN ETL FRAMEWORK

(71) Applicant: CA, Inc., New York, NY (US)

(72) Inventors: David William Cosgrove, JR., Portsmouth, NH (US); Gerald L. Reno, JR., Grafton, MA (US); Jonathan Pantier Caron, Durham, NH (US)

(21) Appl. No.: 15/418,784

(22) Filed: Jan. 30, 2017

(51) Int. Cl. G06F 17/30

(52) U.S. Cl. CPC G06F 17/30563; G06F 17/30321; G06F 17/30292

(57) ABSTRACT

An extensible ETL framework can be designed with components/elements that add and manage request driven customizations to a database and that allow an ETL application to incorporate these customizations into its ETL process without code changes to the ETL application. The extensible ETL framework comprises a data aggregator element (“data aggregator”) that processes customization requests for a database. The data aggregator executes customization requests to create, update and delete custom attributes. The ETL application dynamically detects the custom attributes and associated metadata when executing. The ETL application uses the detected custom attributes and associated metadata to determine source data tables and data values to be extracted from the source data tables to incorporate the custom attributes into the ETL process being performed by the ETL application. The ETL application may alter target data tables that are then loaded with the extracted data values.

### BACKGROUND

The disclosure generally relates to the field of data processing, and more particularly to generic control systems or specific applications.

An extraction, transformation, and loading (ETL) process extracts data from homogeneous or heterogeneous sources, transforms the format of the extracted data to conform to a specified model and schema, and loads the transformed data into a target system (e.g., data warehouse). An ETL process is used to efficiently migrate data from various sources to a unified central repository. Data consolidated in a unified central repository are commonly used in business intelligence applications.

### BRIEF DESCRIPTION OF THE DRAWINGS

Aspects of the disclosure may be better understood by referencing the accompanying drawings.

FIG. 1 depicts an example system for creating or adding a custom attribute requested by a client application.

FIG. 2 depicts an example of the data aggregator processing the request in FIG. 1.

FIG. 3 is a flowchart of example operations for processing a request to add a custom attribute for dynamic incorporation into an ETL process.

FIG. 4 is a flowchart of example operations for dynamically incorporating custom attributes into an ETL process during execution of an ETL application that implements the ETL process.

FIG. 5 depicts an example computer system with an extensible data driven ETL application.

### DESCRIPTION

The description that follows includes example systems, methods, techniques, and program flows that embody aspects of the disclosure. However, it is understood that this disclosure may be practiced without these specific details. For instance, this disclosure refers to an ETL application in illustrative examples. Aspects of this disclosure can be also applied to database applications. In other instances, well-known instruction instances, protocols, structures, and techniques have not been shown in detail in order not to obfuscate the description.

Overview

Off the shelf ETL applications have default functionality out of the box. Organizations are usually limited to the out of the box functionality. Anticipating the requirements of different organizations or the ways these organizations may utilize an ETL application in a rapidly changing business environment is difficult at best. Typically, application code changes are made to accommodate requests, such as additional data sources and/or data to be collected, custom configuration, etc. This is inefficient and time-consuming.

An extensible ETL framework can be designed with components/elements that add and manage request driven customizations to a database and that allow an ETL application to incorporate these customizations into its ETL process without code changes to the ETL application. The extensible ETL framework comprises a data aggregator element (“data aggregator”) that processes customization requests for a database. The data aggregator executes customization requests to create, update and delete custom attributes. The data aggregator may also perform pre-processing procedures on the custom attributes. Pre-processing procedures can include generating metadata and associating the generated metadata to the custom attributes. In addition, the data aggregator can persist the associated metadata in a repository. The ETL application dynamically detects the custom attributes and associated metadata when executing. The ETL application uses the detected custom attributes and associated metadata to determine source data tables and data values to be extracted from the source data tables to incorporate the custom attributes into the ETL process being performed by the ETL application. The ETL application may alter target data tables that are then loaded with the extracted data values based, at least in part, on the detected custom attributes and associated metadata. The target data tables may be dynamically altered by adding a column, changing a data type, etc. to accommodate the extracted data values. These customization based values may then be made available for reporting and/or public access via an open application programming interface (API).

Example Illustrations

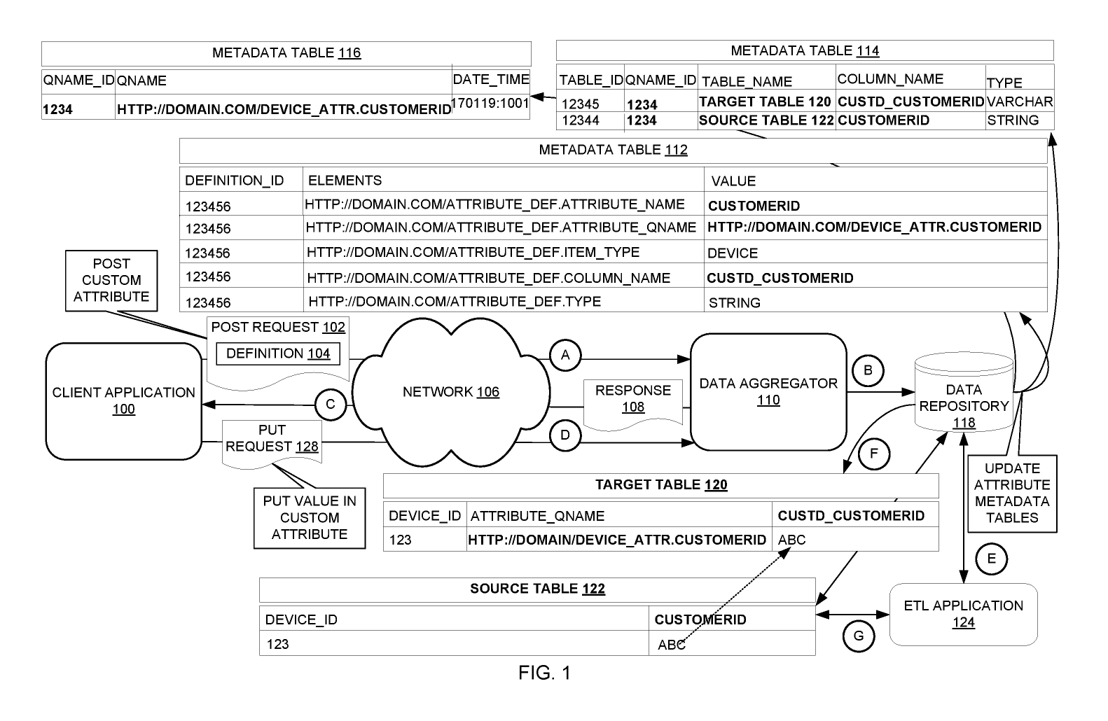

FIG. 1 depicts an example system for creating or adding a custom attribute requested by a client application. FIG. 1 comprises a data aggregator 110, a data repository 118, and an ETL application 124. A client application 100 interacts with the data aggregator 110 to add a custom attribute to the data repository 118 (e.g., database, data warehouse). The data aggregator 110 performs various functions to incorporate the custom attribute and value assigned to the custom attribute into the data repository 118. Upon execution, the ETL application 124 queries the data repository 118 for the custom attribute and the value assigned thereto. In this illustration, at least the data aggregator 110 and tables discussed below in the data repository 118 constitute an extensible ETL framework.

FIG. 1 is annotated with a series of letters A-G. These letters represent stages of one or more operations. Although these stages are ordered for this example, the stages illustrate one example to aid in understanding this disclosure and should not be used to limit the claims. Subject matter falling within the scope of the claims can vary with respect to the order of some of the operations.

At stage A, the client application 100 sends a request 102 (e.g., through a representational state transfer (REST) application program interface (API) call, web service, etc.)) to the data aggregator 110. The client application 100 transmits the request 102 to the data aggregator 110 through a network 106 using a specified uniform resource identifier (URI), such as http://dataAggregator/port/rest/customAttributeDefinition. The request 102 is an extensible markup language (XML) based request that identifies the custom attribute to be added, “customerID.” The request 102 includes a custom attribute definition 104 (hereinafter “definition 104”). The definition 104 comprises information or metadata about the custom attribute (e.g., description, name, data type, etc.). A body of the request 102 includes the definition 104. The definition 104 may be in various formats (e.g., XML, JavaScript Object Notation (JSON), etc.).

At stage B, the data aggregator 110 receives and processes the request 102. Upon receipt, the data aggregator 110 processes the request 102. Processing the request 102 comprises various procedures, such as validating the request 102, manipulating the metadata in the definition 104, and generating a configuration document. Validating the request 102 includes determining if the request 102 can be processed. For example, the request 102 can be processed if a threshold has not been reached. For example, a threshold of custom attributes may be defined for the client application 100 and/or a custom attribute item type. If fulfilling the request 102 will exceed this threshold, the data aggregator 110 can deny the request 102. Manipulating the metadata in the definition 104 includes generating identifiers (IDs) and updating the definition 104. In this example, the data aggregator 110 generates a definition ID (hereinafter “definitionID”) for the definition 104, a qualified name (hereinafter “QName”) for the customerID, and a column name (hereinafter “columnName”). The QName is used as an ID for the customerID. The columnName will contain a data value of the customerID. The data aggregator 110 updates the definition 104 with the QName and the columnName. The configuration document is based, at least in part, on the metadata in the definition 104 and contains information (e.g., a namespace, a schema, a facet, etc.) that may be used to determine properties of the customerID relative to other objects in the data repository 118.

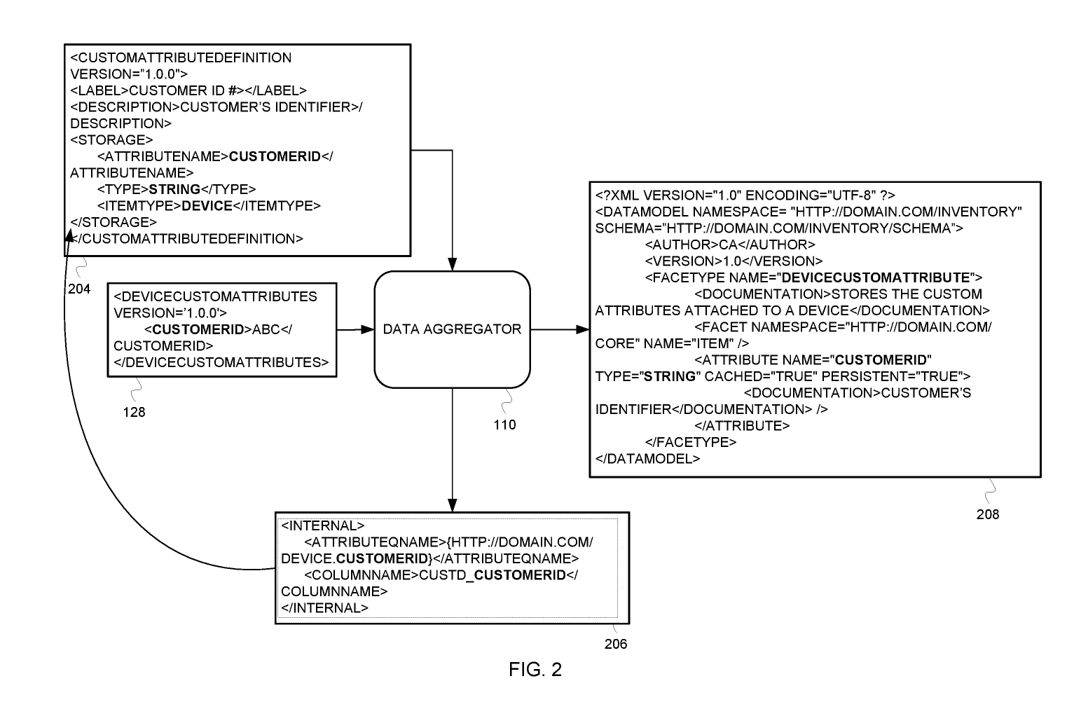

FIG. 2 depicts an example of the data aggregator processing the request 102 in FIG. 1. FIG. 2 depicts the data aggregator 110, a definition 204, a section 206, a configuration document 208, and a request 210. In FIG. 2, the definition 204 contains example code for the definition 104 in FIG. 1. The definition 204 contains information associated with a custom attribute (i.e., the customerID) such as a label, a description, an attribute name, a type (e.g., string, integer), an item type (e.g., device, component port), etc.

Upon receipt of the request 102 in FIG. 1, the data aggregator 110 processes the definition 204. The data aggregator 110 generates a definition ID (i.e., the definitionID) for the definition 204. The definitionID may be alphanumeric, a number, a globally unique identifier (GUID), etc. The data aggregator 110 generates an XML-based section 206 based on processing the definition 204. The data aggregator 110 generates the section 206 with the qualified name QName and the column name columnName, which is based on the QName. The data aggregator 110 associates or maps the QName and columName within the section 206 by placing them within an element “INTERNAL” in the section 206. The data aggregator 110 updates the definition 204 by inserting the section 206 after a STORAGE section of the definition 204. In this example, the QName is a concatenation of a domain name and an attribute name. The domain name may be identified from the URI of the request 102 from FIG. 1, and the attribute name is the value of an element ATTRIBUTENAME in the definition 204. The column name comprises a prefix such as “cust,” and either a “d,” “c,” or “p” for a device, a component, or a port respectively and the value of the element ATTRIBUTENAME in the definition 204.

After updating the definition 204 with the section 206, the data aggregator 110 continues processing the request 102 from FIG. 1. The data aggregator 110 generates and stores the configuration document 208 based, at least in part, on the information in the definition 204. The data aggregator 110 generates the configuration document 208 based on a template (not depicted). The data aggregator 110 determines correspondence or correlates fields or elements of the definition 204 to the template to populate fields/elements of the template to generate the configuration document 208. Correlation can be based mapping locations of fields in the definition 204 to corresponding locations in the template. Correlation can also be based on matching or partially matching names of fields between the definition 204 and the template. The data aggregator 110 can be programmed to recognize matches or partial matches or read another configuration file that specifies how to correlate or map to fields of the template. In this illustration, the value of the element ATTRIBUTENAME in the definition 204 maps to the value of a variable NAME in an ATTRIBUTE section of the configuration document 208. The value of an element TYPE in the definition 204 maps to the value of a variable TYPE in the ATTRIBUTE section of the configuration document 208. The value of the element DESCRIPTION in the definition 204 maps to the value of the variable DOCUMENTATION in the ATTRIBUTE section of the configuration document 208.

The value of an element ITEMTYPE in the definition 204 maps to the prefix of the value of a variable NAME in a FACETTYPE section of the configuration document 208. The value of the element ITEMTYPE in the definition 204 is also propagated in the DOCUMENTATION element of the FACETTYPE section. Other values in the configuration document 208 such as the FACETTYPE section can be populated using defaults based, at least in part, on values in the definition 204, such as the item type. For example, the value of the variable NAMESPACE of the FACET element in the configuration document 208 is a default name space for the device. Other values have standard default settings if not specified. For example, the default value of the variable CACHED is “true.”

Referring again to FIG. 1, the data aggregator 110 then updates metadata tables 112, 114, and 116 using the metadata in the definition 104 and the information in the configuration document 208. The metadata table 116 is a lookup table that tracks the added custom attributes. The metadata table 114 is a mapping table that tracks the association of a target table with both a column name and a qualified name of the custom attribute. The metadata table 112 tracks the metadata in the definition 104. For example, the data aggregator 110 updates the metadata table 116 by adding a row containing the QName of the customerID. The QName is associated with a QName identifier which is unique across the qualified names. A timestamp generated by the data aggregator 110 is also added to identify when the custom attribute was processed. The data aggregator 110 updates the metadata table 112 by adding a corresponding row in metadata table 112 for each element in the definition 104 and associating the element with the definitionID. The data aggregator 110 updates metadata table 114 by adding a row containing an extraction source (in this illustration the source table name), a column name and type. The data aggregator 110 further updates the metadata table 114 by adding a row containing a load target (in this illustration a target table name), the columnName, and a type for the customerID. The data aggregator 110 determines the target table name by querying the schema in a DATAMODEL section of the configuration document 208. The data aggregator 110 determines the columnName by querying the value of an element HTTP://DOMAIN.COM/ATTRIBUTE_COLUMN_NAME in the metadata table 112. The data aggregator 110 determines the type by querying the value of an element HTTP://DOMAIN.COM/ATTRIBUTE_DEF.TYPE in the metadata table 112 and then translating the queried value into a format that is recognized by the data repository 118. For example, the data aggregator 110 translates the queried value using a data structure (e.g., hash table) that contains an association or map between the various data types. In this example, a data type STRING maps to a data type VARCHAR.

At stage C, the data aggregator 110 transmits a response 108 to the client application 100 after processing the request 102. The response 108 contains the definitionID. The data aggregator 110 returns the definitionID as part of the response 108 because the request 102 has been successfully processed. Otherwise, the response 108 would contain a hypertext transfer protocol (HTTP) error status code (e.g., “406”). An error may be returned for various reasons, such as when the data aggregator 110 is unable to service the request 102 because the definition 104 is malformed.

At stage D, after the client application 100 receives the definitionID in the response 108, the client application 100 sends a PUT request 128 (hereinafter “request 128”) to the data aggregator 110. The request 128 contains a value of the custom attribute that was earlier added by the request 102 (i.e., the customerID). The value of the customerID contained in the request 128 is stored in a source table 122 by the data aggregator 110. In this example, the attribute name customerID is used as a column name to contain the value of the custom attribute. Returning to FIG. 2, the request 128 contains example code of the request 128 in FIG. 1. As depicted in the request 128, a value “ABC” is set for the customerID.

Returning to FIG. 1, at stage E, upon execution, the ETL application 124 determines if there is any custom attribute for processing by querying the metadata table 116. In this example illustration, metadata table 116 only illustrates one custom attribute. The query retrieves the QName of the customerID.

At stage F, the ETL application 124 creates a target table 120. The ETL application 124 determines the parameter values to be used in creating the target table 120 (e.g., target table name, column name, data type, size, etc.) in part by querying the metadata table 114 for the target table name, column name and type using the retrieved QName.

At stage G, the ETL application 124 extracts the data value of the customerID “ABC” from the source table 122 and loads the extracted data value into the target table 120. The ETL application 124 determines the name of the source table using the value of a variable SCHEMA in a section DATAMODEL of the configuration document 208. The extracted data value may be transformed prior to loading. For example, the data type of the extracted data value from a column CUSTOMERID of the source table 122 may be translated to the data type of a column CUSTD_CUSTOMERID of the target table 120. In another example, the format of the extracted data value may be changed (e.g., upper case to lower case).

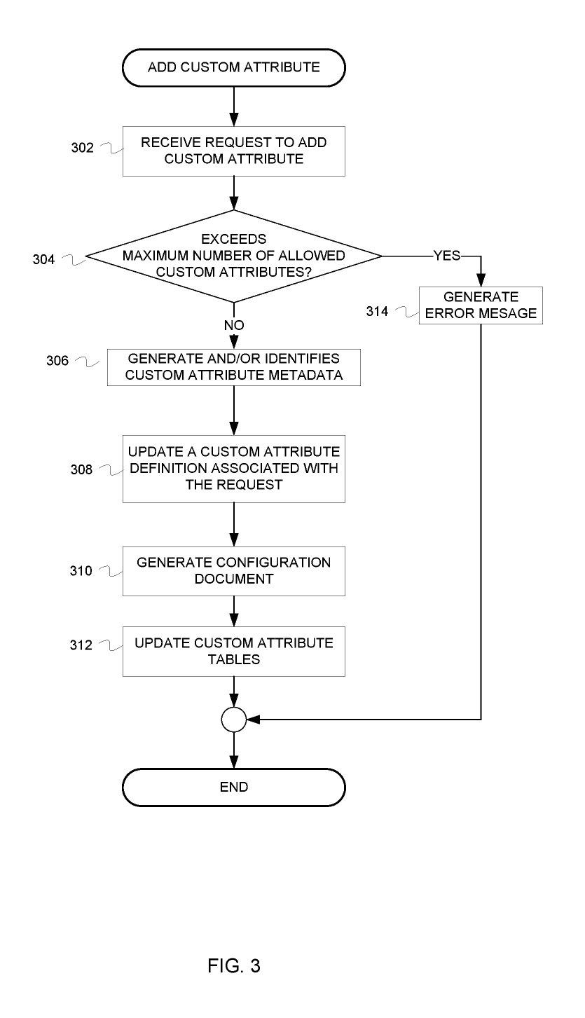

FIG. 3 is a flowchart of example operations for processing a request to add a custom attribute for dynamic incorporation into an ETL process. The description in FIG. 3 refers to the data aggregator 110 of FIG. 1 as performing the sample operations for consistency with FIG. 1.

The data aggregator receives a request to add a custom attribute from a client (302). A client may be an application, a web service, etc. The custom attribute to be added may be an attribute of an object managed by the client (e.g., network device, device component, etc.) The request may be submitted through various means such as through an HTTP request (e.g., REST API, Simple Object Access Protocol (SOAP)), a method call, a command received via command line, or an API call). The request to add a custom attribute may contain a request to add one custom attribute or several custom attributes. The request contains a definition for the custom attribute(s) to be added. The definition comprises structured information (e.g., custom attribute properties) about the custom attribute(s) used by the data aggregator to create or update tables used by an ETL application to incorporate the custom attribute into the ETL process. The definition may be encoded in a request body or attached with the request. The definition may be encoded in various formats such as XML, JSON, “application/x-www-form-urlencoded”, etc. For example, if the definition is encoded in XML, the definition elements of the custom attribute may be expressed as document elements. For example, if the definition is encoded in XML, the definition elements may be expressed as elements in the XML document. In another example, if the definition is encoded in JSON format, the definition elements may be expressed as objects. In addition to the information contained in the definition, the request may contain other information regarding the custom attribute(s) such as a timestamp, a client ID, etc.

After receiving the request to add the custom attribute from the client, the data aggregator determines if the total number of custom attributes would exceed the maximum number of allowed custom attributes after the addition (304). The data aggregator may maintain a counter on how many custom attributes have been added for a database. The data aggregator may be configured to set the maximum number of custom attributes based on various factors. For example, the data aggregator may be configured to set a different maximum custom attribute for each item type (e.g., a device, a port, a component), each client, etc.

If the maximum number of attributes would not be exceeded, the data aggregator generates and/or identifies metadata associated with the custom attribute (306). The data aggregator generates an ID for the custom attribute and/or the definition. In this example, a qualified name is generated and used as the ID for the custom attribute. The data aggregator may use a rule(s) in generating the qualified name. For example, the qualified name may be generated according to a rule that specifies concatenation of various data values of the definition elements of the custom attribute (e.g., client name, customer attribute name, domain name, etc.) The definition ID (i.e., the definitionID as referred to in FIG. 1) may also be generated according to a similar rule. In another example, the generation of the definitionID may be determined by a different set of rules.

The data aggregator also generates a configuration value(s) that may be used in processing the custom attribute (e.g., a target table column name and data type). The data aggregator may also keep track of when the request was received or processed by generating a timestamp. The timestamp may be depicted in various formats (e.g., date/time, Epoch time, etc.)

The configuration value(s) generated includes a column name. The column name is used to add a column to a target table that will contain the value of the custom attribute. The column name may be of various formats (e.g., alphabetic, alphanumeric, etc.). Similar to the qualified name, the data aggregator may use a rule(s) in generating the column name. The data aggregator may also generate other configuration values such as the name of the target table, the column data type, target table size, etc.

After generating the custom attribute metadata, the data aggregator updates the definition (308). The data aggregator updates the definition by adding the qualified name and configuration value(s). For example, if the definition is encoded in XML, then the qualified name and configuration value(s) may be encoded in an XML-based format as text values contained in elements. The configuration values are then inserted in the definition according to a predetermined convention. For example, the configuration values are inserted after the STORAGE section of the definition.

After updating the definition, the data aggregator generates a configuration document (310). The configuration document includes information such as the name and location of the database schema, a facet of the custom attribute, etc. The data aggregator generates the configuration document based, at least in part, on the definition and a previously created configuration template. The data aggregator may also generate the configuration document based on other values in the request. For example, the schema name, facet and/or namespace may be identified in the request (e.g. request header). Different configuration templates can be created for different devices, different customers, etc.

The data aggregator may also use rules in generating the configuration document. For example, the schema, facet, and/or name space may be determined based on the item type indicated in the attribute definition. There may be a default schema, facet and/or name space for a device, a component and/or a port. The data aggregator may also query a mapping or lookup table to determine the schema, the facet, and/or the namespace based on other factors, such as the client ID. For example, a separate schema, facet, and/or namespace may exist for each client ID.

The schema defines the source and target data configuration. The source data configuration contains information on where the custom attribute values will be extracted from. The target data configuration contains information on where the extracted values should be loaded into. In this example, the source and target data configurations are relational database tables. So, the schema in this example defines the source and target tables, fields, relationships, procedures, etc., for each client.

The source and target data configuration may also be determined from a properties file. The properties file may be stored in a database server, ETL application server, or a common file repository. If a properties file is used to determine the configuration, then the properties file name and/or location would be contained in the definition instead of the schema.

The name space is used so that the names of the information in the source data and target data configuration is unique for each client. For example, the source and target tables cannot have the same name because they are in the same namespace.

A facet is a property of a custom attribute that is used for classification of the custom attribute. A custom attribute can have 1 to n facets used to classify the custom attribute. For instance, “item type” may be a facet of a custom attribute and the value assigned to the facet used for evaluating criteria for how to ingest or incorporate the custom attribute into a database. For example, the custom attributes may belong to a device, port, or component class. A facet namespace may be used to enforce uniqueness to some properties of the custom attribute within the facet. For example, the value of the attribute name should be unique among all the devices within the device class. The facet may also be used for reporting. External applications and/or services may also use the facet when retrieving values from the target tables. Various properties in the configuration document may indicate how these applications, services, etc. may retrieve these values. For example, a reporting service may be updated automatically or periodically.

After generating the configuration document, the data aggregator updates custom attribute metadata tables used for dynamically incorporating custom attributes into an ETL process (312). The data aggregator determines the values to be used for updating the metadata tables by parsing the definition, the configuration document, and the request. The data aggregator also generates and/or identifies the values by querying the information from other sources such as another metadata table(s). Instead of storing the information in metadata tables, the data aggregator may also store the information in a file repository. For example, the data aggregator may store the definition and the configuration document as XML documents.

The metadata tables comprise a qualified names table, a source and target data configuration mapping table (hereinafter “mapping table”) and a custom attribute definition table (hereinafter “definition table”). The qualified names table contains the qualified names (i.e., the QName as referred to in FIG. 1) of the custom attributes added, an identifier for the qualified name (hereinafter “QName ID” as referred to in FIG. 1), the timestamp, etc. The qualified names table contains the added custom attributes and is used as a lookup table. The identifier for the qualified name may be a numerical sequence to keep track of the number of custom attributes. Accordingly, the identifier is unique across the database. The database aggregator can assign the identifier in ascending order starting from some initial value to ensure that there is no duplication among the identifiers. In another example, an accumulator may be used to keep track of the sequence of the added custom attributes.

The definition table contains the information or the properties of the custom attribute added to the ETL framework. The values in the definition table are based, at least in part, from the elements contained in the updated definition received with the request. The data aggregator inserts a row in the definition table for each information about the custom attribute (e.g., custom attribute property, element, object, etc.) contained in the definition. As stated earlier, the data aggregator generates a definition ID (i.e., definitionID) for the definition. The definitionID is a unique identifier across the requests. The definitionID associates each element in the definition table to the definition.

The mapping table contains the source and target table names, source and target column names, and the custom attribute data types. The mapping table also contains a unique identifier for each of the source or the target tables across the database. Also, the mapping table contains the QName ID which associates the source and target table to the QName of the custom attribute. In another example, the mapping table may contain the QName of the custom attribute instead of the QName ID. The QName is used to join the lookup table, definition table, and mapping table when performing queries and/or updates. The metadata tables depicted may contain additional information other than shown in this illustration. Also, there may be more metadata tables than depicted in this illustration.

If the maximum number of the custom attributes would be exceeded (304), the data aggregator does not process the request. Instead, the data aggregator generates an error message (314). The data aggregator may propagate the error message using HTTP response status codes. The data aggregator may also log the error and/or generate a trace file. The error log and/or trace file may be used to identify and extract issues or potential issues such as an exception and a specific error message

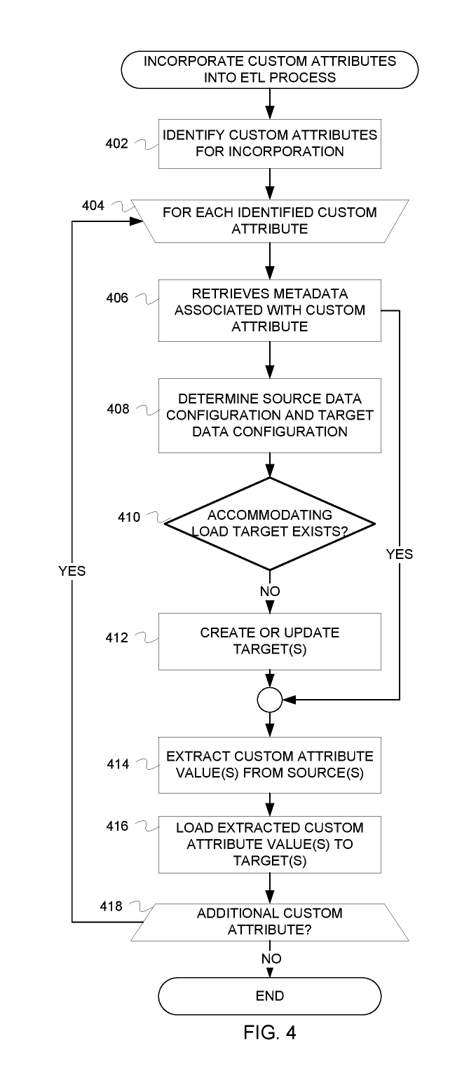

FIG. 4 is a flowchart of example operations for dynamically incorporating custom attributes into an ETL process during execution of an ETL application that implements the ETL process. The description in FIG. 4 refers to the ETL application as performing the example operations for consistency with FIG. 1. The ETL application can be set to execute periodically at fixed times, dates, or intervals. The ETL application may also execute on-demand.

Upon execution, the ETL application identifies custom attributes to be incorporated (402). The ETL application may identify the custom attributes by retrieving custom attribute identifiers from a qualified names table in a data repository using a structured query language (SQL) query or an API request. The ETL application may retrieve the qualified names of all the custom attributes or some of the custom attributes from the qualified names table. As stated earlier, the qualified names table contains the qualified names of the custom attributes. The ETL application may identify custom attributes for incorporation into the ETL process according to criteria or constraints to be applied. The ETL application can create and submit a query to the metadata tables with query parameters based on the constraints. For example, the ETL application may identify the first 100 custom attributes from the data repository using a qualified name identifier (i.e., the QName ID). In another example, the ETL application may identify the most recent 100 custom attributes according to a timestamp associated with the custom attribute qualified name (i.e., the QName). A timestamp may be used to extract the custom attributes added most recently. For example, the data aggregator may identify custom attributes added after a certain date and/or time. The timestamp may be stored in another table such as a custom attribute definition table (i.e., the definition table from FIG. 3). The ETL application may identify custom attributes of item type device. In performing the identification, the ETL application joins the qualified names table with the definition table. In yet another example, the data aggregator may identify custom attributes based on a client ID, from a specific source table, etc.

The ETL application begins processing each identified custom attribute (404). The custom attribute currently being processed by the ETL application is hereinafter referred to as the “selected custom attribute.”

The ETL application retrieves metadata associated with the selected custom attribute (406). The ETL application may retrieve the metadata associated with the selected custom attribute from a data repository with a query that includes a definition ID as a query parameter. The definition was created when the custom attributes was created and defined. The ETL application may retrieve all the metadata or some of the metadata associated with the selected custom attribute. For example, the ETL application may retrieve the most recent metadata associated with a custom attribute ID. The ETL application may retrieve the most recent metadata using a timestamp. For example, if a request to update the definition of a custom attribute was received earlier, the data aggregator may retrieve the information from the update.

The ETL application determines the source data configuration and target data configuration by querying a mapping table that maps extraction sources and load targets to custom attributes (408). As stated earlier, the source data configuration indicates location of the custom attribute values for extraction. The target data configuration indicates where to load the extracted custom attribute values. For example, the source data configuration includes information such as the source table name(s), column name(s), data type(s), etc. In addition, the source data configuration may include information such as username, password, port, etc. to access and query the source table(s). The target data configuration includes information such as the target table name(s), column name(s), data type(s), etc. Similar to the source data configuration, the target data configuration may also include information such as username, password, port, etc. to access the target table. Other information (e.g., column name, data type, and size of the column) associated with the source table and target table may be determined from other sources such as a metadata table (e.g., the mapping table from FIG. 3). Instead of database tables, the custom attribute values may be contained in text files (e.g., comma separated value (CSV) files), a spreadsheet, XML-based documents, etc.

The ETL application determines if a target(s) according to the target configuration exists (410). As the target(s) may be deleted during a cleanup process upon the execution of the ETL application, the ETL application would determine if the target(s) exists. For example, the ETL application determines if the target table with a column that can accommodate the extracted custom attribute values by comparing the data type and size of the column in the target table to the information extracted in the block 408. The ETL application can determine if the target table exists by using various means such as querying the database system table, catalog, information schema, etc.

If the target configuration does not exist, the ETL application creates or updates the target(s) (412). For example, the target table(s) can be created using a SQL script, a database modeling tool, etc. Various parameters such as table name(s), column name(s), data type(s), and size of the column(s) previously determined from a mapping table (408) may be used when creating the target table(s). In another example, the target table(s) may exist but cannot accommodate the custom attribute value(s) to be extraction. Thus, the target table would be updated. For example, the size of the column(s) may be increased.

After creating or updating the custom attribute loading target, the ETL application extracts the selected custom attribute value(s) from the source(s) based on the information from block 408 (414). As stated earlier, the source(s) may be a database table, a text file, etc. The ETL application may extract custom attributes according to parameters or constraints to be applied. For example, the ETL application queries the source table(s) for the values of the selected custom attribute using the custom attribute name. In another example, the source table may contain the QName of the custom attribute. The extracted values may be transformed to conform to the target data configuration format prior to loading the extracted values to the target tables. For example, if the extracted value is a date, the date format may be changed. Additional pre-processing may be performed prior to loading, such as summarization, aggregation, checking integrity constraints, etc.

After extracting the selected custom attribute value(s), the ETL application loads the values to the target(s) based on the information from block 408 (416). As stated earlier, the target may be a database table, text file, etc. The ETL application may load custom attributes according to parameters or criteria to be applied. For example, the ETL application may load the most recent custom attribute values. After loading, the customization based values loaded into the loading target (s) are available for reporting and analysis.

The ETL application determines if there is an additional custom attribute to be processed (418). If there is an additional custom attribute to be processed, then the next custom attribute is selected (404). If there is no additional custom attribute to be processed, then the process ends.

Variations

The examples presume that a data aggregator first performs the processing of a request to add a custom attribute. After processing, the data aggregator stores the custom attribute in a data repository. Upon execution, the ETL application determines the added custom attributes by querying the data repository. The ETL application may also process the request and/or store the custom attribute, wherein the ETL application receives the request from client applications, processes the request and stores the custom attribute(s).

The examples presume that the addition of the custom attribute(s) is performed via the request-response paradigm. The addition of custom attribute(s) may use a publish-subscribe paradigm instead, wherein the custom attributes to be added will be published. Subscribers receive the custom attributes(s) and transmit the custom attribute(s) to the data aggregator.

The examples presume that the ETL application determines the custom attribute(s) added upon execution on a periodic basis. The ETL application may instead determine deltas of the custom attribute(s) added. For example, the ETL application determines that a custom attribute “A” was added upon a first execution of the ETL application. The ETL application may set a flag to identify the custom attributes that have been added. In another implementation, the ETL application may maintain a separate data structure that contains the added custom attributes. On a second execution; the ETL application determines if there are changes or deltas to the added custom attributes. For example, the ETL application determines whether there are changes to the properties of the custom attribute A or a new custom attribute (e.g., a custom attribute B) was added.

The examples often refer to a “data aggregator.” The data aggregator is a construct used to refer to the implementation of functionality for processing requests to add custom attributes. This construct is utilized since numerous implementations are possible. The term is used to explain the content of the disclosure efficiently. Although the examples refer to operations being performed by a data aggregator, a method, program, or function with a different name can perform the operations.

The examples often refer to a database as the source of the custom attribute values to be extracted. The ETL application may also extract the custom attribute values without the use of an intermediate data repository. For example, the custom attribute values may be streamed from devices, data collectors, etc.

The examples refer to a qualified name for a custom attribute as being provided by a client or customer and mapping a custom attribute identifier generated by the extensible ETL framework to the qualified name. The qualified name is an example illustration. The extensible ETL framework generates an identifier to be used internally for ensuring uniqueness of custom attributes across database regardless of what requestors use to identify their customer attributes. Thus, an extensible ETL framework is not limited to an incrementing counter to generate an internal identifier for a custom attribute and can use a variety of other techniques for internal identification of a custom attribute separate from requestor (e.g., client or customer) identification techniques. For instance, an extensible ETL framework can generate an internal identifier for a custom attribute based on the requestor identifier (e.g., combination of requestor's custom attribute identifier and an identifier that identifies the requestor).

The examples often refer to a mapping table containing the names and identifiers of database tables as the sources and targets of the custom attributes to be extracted and loaded into. Because the source from which to extract the custom attribute values (“extraction source”), and/or the target to which to load the extracted custom attribute values (“loading target”), may not be database tables, the mapping table may instead contain a name or location from which to extract the custom attribute values from and/or name or location to load the extracted custom attribute values such as absolute file paths. The name of location of the extraction source and the loading target is associated with a unique identifier for each of the extraction source and/or loading target across the ETL framework.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 402 and 406 can be performed in based on a single method/function call. With respect to FIG. 3, updating a custom attribute table (312) may not be allowed or may not be performed. The ETL application may instead parse the definition and configuration documents upon each execution. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

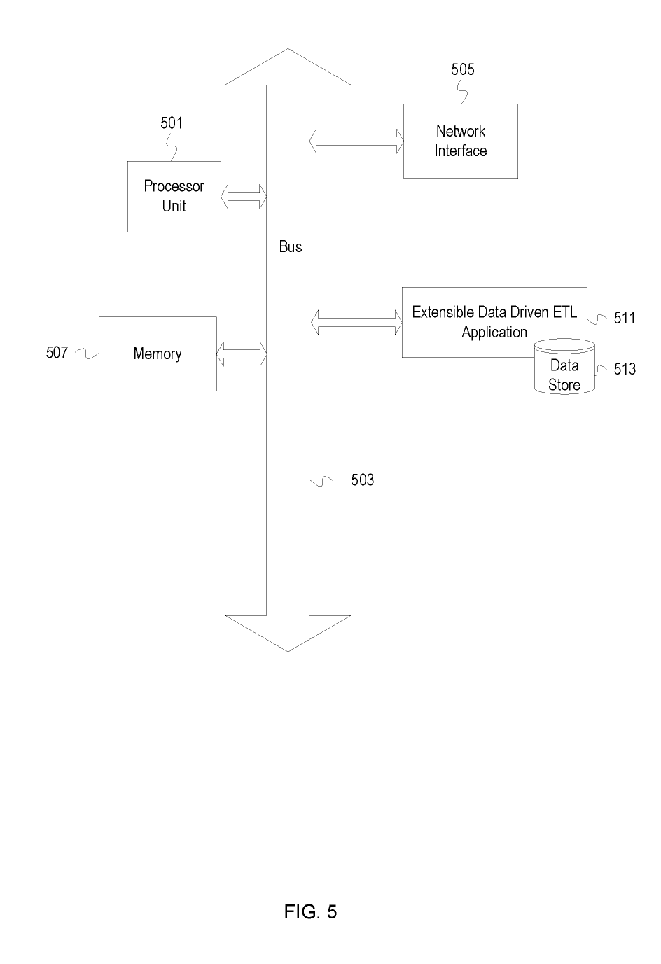

FIG. 5 depicts an example computer system with an extensible data driven ETL application. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes an extensible data driven ETL application 511 and a data store 513. The extensible data driven ETL application 511 automatically detects additional custom attribute values to be extracted, transformed and loaded into target database tables. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for automatically detecting custom attributes to be processed as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
based on receipt of a request to add a custom attribute and an attribute value for the custom attribute to a database,
generating a custom attribute identifier for the custom attribute and an attribute definition identifier for a definition of the custom attribute indicated in the request;
generating a configuration document for the custom attribute based, at least in part, on the custom attribute definition and a configuration template associated with the database,
wherein the configuration template at least indicates a database schema for the database,
wherein generating the configuration document for the custom attribute comprises determining correspondence between definition values in the custom attribute definition and definition elements indicated in the configuration template;
updating a first structure to indicate the correspondence between the definition values and the definition elements for the custom attribute;
determining a loading target identifier and an extraction source identifier indicated in the database schema;
updating a second structure to associate the extraction source identifier with the custom attribute identifier and to indicate an extraction source attribute name for tracking the custom attribute in an extraction source; and
updating the second structure to associate the loading target identifier with the custom attribute identifier and to indicate a loading target attribute name for tracking the custom attribute in a loading target.

2. The method of claim 1, wherein generating the configuration document comprises generating the configuration document with definition values assigned to the definition elements according to the determined correspondence, wherein the definition elements comprise extraction parameters for extracting data from a source object corresponding to the custom attribute.

3. The method of claim 1, wherein determining correspondence between definition values in the custom attribute definition and definition elements indicated in the configuration template comprises at least one of determining correspondence between names of the definition values and the definition elements and determining correspondence between locations of the definition values within the custom attribute definition and locations of the definition elements within the configuration template.

4. The method of claim 1, wherein determining the extraction source identifier and the loading target identifier comprises determining the extraction source identifier as a first table name specified in the database schema, and the loading target identifier as a second table name specified in the database schema.

5. The method of claim 4 further comprising:
creating the extraction source as a first table with an entry for an object related to the custom attribute and a column identified with the extraction source attribute name, the entry created to at least indicate the attribute value for the custom attribute, an object identifier that identifies the object, and the custom attribute identifier.

6. The method of claim 5, wherein the object is a managed object of a network.

7. The method of claim 5, further comprising:
during an extraction, loading, and transformation process with the database, creating the loading target as a second table with an entry for the object related to the custom attribute and a column identified with the loading target attribute name, the entry created to at least indicate the attribute value for the custom attribute, the object identifier that identifies the object, and the custom attribute identifier.

8. The method of claim 1, further comprising:
updating a third structure that associates the custom attribute identifier with a second identifier of the custom attribute indicated in the request,
wherein updating the first structure comprises updating the first structure with the custom attribute identifier as an index or key; and
wherein updating the second structure comprises updating the second structure with the custom attribute identifier as an index or key.

9. One or more non-transitory machine-readable media comprising program code for dynamically incorporating custom attributes into a database, the program code to:
identify a custom attribute of an object for incorporation into an extraction, transformation, and loading process;
based on an identifier of the custom attribute and an identifier of the object, determine a loading target identifier and loading parameters from a first structure and an extraction source identifier and extraction parameters indicated in a second structures;
extract a custom attribute value of the identified custom attribute from an extraction source identified with the extraction source identifier, wherein the extraction is based, at least in part on the extraction parameters; and
load the extracted custom attribute value to a loading target identified with the loading target identifier, wherein the loading is based, at least in part on the loading parameters.

10. The machine-readable media of claim 9, wherein the program code to identify the custom attribute for incorporation comprises program code to identify attributes in the database indicated in the database as custom.

11. The machine-readable media of claim 9, wherein the program code to determine the extraction parameters comprises program code to:
access an entry of the second structure using the custom attribute identifier; and
read from the entry in the second structure the extraction source identifier and a name of an element of the extraction source from which to extract the custom attribute value.

12. The machine-readable media of claim 9, wherein the program code to determine the loading parameters comprises program code to access an entry in the first structure using the custom attribute identifier and to read from the entry the loading target identifier and a name of an element of the loading target to load the custom attribute value.

13. An apparatus comprising:
a processor; and
a machine-readable medium having program code executable by the processor to cause the apparatus to,
based on receipt of a request to add a custom attribute and an attribute value for the custom attribute to a database, generate a custom attribute identifier for the custom attribute and an attribute definition identifier for a definition of the custom attribute indicated in the request;
generate a configuration document for the custom attribute based, at least in part, on the custom attribute definition and a configuration template associated with the database,
wherein the configuration template at least indicates a database schema for the database,
wherein the program code executable by the processor to cause the apparatus to generate the configuration document for the custom attribute comprises program code executable by the processor to cause the apparatus to determine correspondence between definition values in the custom attribute definition and definition elements indicated in the configuration template;
update a first structure to indicate the correspondence between the definition values and the definition elements for the custom attribute;
determine a loading target identifier and an extraction source identifier indicated in the database schema;
update a second structure to associate the extraction source identifier with the custom attribute identifier and to indicate an extraction source attribute name for tracking the custom attribute in an extraction source; and
update the second structure to associate the loading target identifier with the custom attribute identifier and to indicate a loading target attribute name for tracking the custom attribute in the loading target.

14. The apparatus of claim 13, wherein the program code executable by the processor to cause the apparatus to generate the configuration document comprises program code executable by the processor to cause the apparatus to generate the configuration document with definition values assigned to the definition elements according to the determined correspondence, wherein the definition elements comprise extraction parameters for extracting data from a source object corresponding to the custom attribute.

15. The apparatus of claim 13, wherein the program code executable by the processor to cause the apparatus to determine correspondence between definition values in the custom attribute definition and definition elements indicated in the configuration template comprises program code executable by the processor to cause the apparatus to, at least one of, determine correspondence between names of the definition values and the definition elements and determine correspondence between locations of the definition values within the custom attribute definition and locations of the definition elements within the configuration template.

16. The apparatus of claim 15, wherein the program code comprises program code executable by the processor to cause the apparatus to:
create the extraction source as a first table with an entry for an object related to the custom attribute and a column identified with the extraction source attribute name, the entry created to at least indicate the attribute value for the custom attribute, an object identifier that identifies the object, and the custom attribute identifier.

17. The apparatus of claim 16, wherein the object is a managed object of a network.

18. The apparatus of claim 16, wherein the program code comprises program code executable by the processor to cause the apparatus to:
during an extraction, loading, and transformation process with the database, create the loading target as a second table with an entry for the object related to the custom attribute and a column identified with the loading target attribute name, the entry created to at least indicate the attribute value for the custom attribute, the object identifier that identifies the object, and the custom attribute identifier.

19. The apparatus of claim 13, wherein the program code comprises program code executable by the processor to cause the apparatus to:
update a third structure that associates the custom attribute identifier with a second identifier of the custom attribute indicated in the request,
wherein program code executable by the processor to cause the apparatus to update the first structure comprises program code executable by the processor to cause the apparatus to update the first structure with the custom attribute identifier as an index or key; and
wherein program code executable by the processor to cause the apparatus to update the second structure comprises program code executable by the processor to cause the apparatus to update the second structure with the custom attribute identifier as an index or key.

20. The apparatus of claim 13, wherein the program code to cause the apparatus to determine the extraction source identifier and the loading target identifier comprises program code executable by the processor to cause the apparatus to determine the extraction source identifier as a first table name specified in the database schema, and the loading target identifier as a second table name specified in the database schema.
